(19) United States
(12) Patent Application Publication
(10) Pub. No.: US 2022/0396517 A1
(43) Pub. Date: Dec. 15, 2022

(54) METHODS AND APPARATUS FOR MANUFACTURING A GLASS RIBBON

(71) Applicant: Corning Incorporated, Corning, NY (US)

(72) Inventors: Jeffrey Howard Ahrens, Davidson, NC (US); Franck Olivier Hounkpevi, Painted Post, NY (US); Philip Robert LeBlanc, Corning, NY (US); Robert Arthur McIntosh, Painted Post, NY (US)

(21) Appl. No.: 17/774,686

(22) PCT Filed: Nov. 25, 2020
(86) PCT No.: PCT/US2020/062122

§ 371 Date: May 5, 2022

Related U.S. Application Data
(60) Provisional application No. 62/942,258, filed on Dec. 2, 2019.

(51) Int. Cl. C03B 17/06; G01B 11/06

(52) U.S. Cl. CPC C03B 17/067; C03B 17/064; G01B 11/0691

(57) ABSTRACT

Methods of manufacturing a glass ribbon include moving a ribbon of glass-forming material along a travel path in a travel direction. Methods include sensing a thickness of the ribbon of glass-forming material at a plurality of locations of the ribbon of glass-forming material. Methods include identifying a location of the plurality of locations in which a corresponding thickness at the location exceeds a target thickness. Methods include correlating a rate of thickness change and a thickness difference between the corresponding thickness and the target thickness to a laser power. Methods include directing a laser beam at the laser power toward the ribbon of glass-forming material to decrease a viscosity at the location and attain the target thickness at the location.

### CROSS-REFERENCE TO RELATED APPLICATIONS

This application claims the benefit of priority under 35 U.S.C. § 119 of U.S. Provisional Application Ser. No. 62/942,258 filed on Dec. 2, 2019 the content of which is relied upon and incorporated herein by reference in its entirety.

### FIELD

The present disclosure relates generally to methods for manufacturing a glass ribbon and, more particularly, to methods for manufacturing a glass ribbon by controlling a thickness of the glass ribbon.

### BACKGROUND

It is known to manufacture molten material into a glass ribbon with a glass manufacturing apparatus. To produce a glass ribbon having a target thickness, the thickness of the glass ribbon can be measured. However, measuring the thickness of the glass ribbon may necessitate adjusting a thickness at a location of the glass ribbon if a thickness at the location deviates from the target thickness.

### SUMMARY

The following presents a simplified summary of the disclosure to provide a basic understanding of some embodiments described in the detailed description.

In some embodiments, methods of manufacturing a glass ribbon can comprise a control device that can control a thickness of a ribbon of glass-forming material. A thickness sensor can sense the thickness as the ribbon of glass-forming material moves along a travel path in a travel direction, or, in some embodiments, the thickness sensor can sense the thickness after the separation of a first ribbon portion. A control device can identify any locations of the ribbon of glass-forming material that deviate from a target thickness. The control device can control a laser apparatus and/or a cooling tube to provide localized heating and/or cooling to the ribbon of glass-forming material. The control device can further account for any time delays and/or process disturbances that may occur, thus providing for more accurate thickness control of the ribbon of glass-forming material.

In accordance with some embodiments, methods of manufacturing a glass ribbon can comprise moving a ribbon of glass-forming material along a travel path in a travel direction. Methods can comprise sensing a thickness of the ribbon of glass-forming material at a plurality of locations of the ribbon of glass-forming material. Methods can comprise identifying a location of the plurality of locations in which a corresponding thickness at the location exceeds a target thickness. Methods can comprise correlating a rate of thickness change and a thickness difference between the corresponding thickness and the target thickness to a laser power. Methods can comprise directing a laser beam at the laser power toward the ribbon of glass-forming material to decrease a viscosity at the location and attain the target thickness at the location.

In some embodiments, the identifying can comprise identifying a second location of the plurality of locations in which a second corresponding thickness at the second location is less than the target thickness.

In some embodiments, methods can comprise directing a cooling fluid toward the ribbon of glass-forming material to increase a viscosity at the second location and attain the target thickness at the second location.

In some embodiments, methods can comprise flowing a first stream of glass-forming material over a first weir of a forming wedge. Methods can comprise flowing a second stream of glass-forming material over a second weir of the forming wedge. Methods can comprise fusing the first stream of glass-forming material and the second stream of glass-forming material to form a fused ribbon.

In some embodiments, the directing the laser beam can comprise directing the laser beam toward one or more of the first stream of glass-forming material flowing over the first weir, the second stream of glass-forming material flowing over the second weir, or the fused ribbon.

In some embodiments, sensing the thickness of the ribbon of glass-forming material can occur at the plurality of locations spaced apart along a first axis substantially perpendicular to the travel direction.

In some embodiments, sensing the thickness of the ribbon of glass-forming material can occur in a first ribbon portion of the ribbon of glass-forming material after separating the first ribbon portion from a second ribbon portion of the ribbon of glass-forming material.

In accordance with some embodiments, methods of manufacturing a glass ribbon can comprise moving a ribbon of glass-forming material along a travel path in a travel direction. Methods can comprise sensing a thickness of the ribbon of glass-forming material at a plurality of locations of the ribbon of glass-forming material. Methods can comprise identifying a first location of the plurality of locations in which a first corresponding thickness at the first location exceeds a target thickness and a second location of the plurality of locations in which a second corresponding thickness at the second location is less than the target thickness. Methods can comprise directing a laser beam toward the ribbon of glass-forming material to decrease a viscosity at the first location and attain the target thickness at the first location. Methods can comprise directing a cooling fluid toward the ribbon of glass-forming material to increase a viscosity at the second location and attain the target thickness at the second location.

In some embodiments, methods can comprise flowing a first stream of glass-forming material over a first weir of a forming wedge. Methods can comprise flowing a second stream of glass-forming material over a second weir of the forming wedge. Methods can comprise fusing the first stream of glass-forming material and the second stream of glass-forming material to form a fused ribbon.

In some embodiments, directing the laser beam can comprise directing the laser beam toward one or more of the first stream of glass-forming material flowing over the first weir, the second stream of glass-forming material flowing over the second weir, or the fused ribbon.

In some embodiments, the sensing the thickness of the ribbon of glass-forming material can occur in a first ribbon portion of the ribbon of glass-forming material after separating the first ribbon portion from a second ribbon portion of the ribbon of glass-forming material.

In some embodiments, methods can comprise calculating a time delay between the separating of the first ribbon portion and the sensing of the thickness. Methods can comprise directing the laser beam and the cooling fluid toward the second ribbon portion based on the time delay.

In accordance with some embodiments, methods of manufacturing a glass ribbon can comprise moving a ribbon of glass-forming material along a travel path in a travel direction. Methods can comprise separating a first ribbon portion of the ribbon of glass-forming material from a second ribbon portion of the ribbon of glass-forming material. Methods can comprise sensing a thickness at a plurality of locations of the first ribbon portion. Methods can comprise identifying a first location of the plurality of locations in which a corresponding thickness at the first location exceeds a target thickness. Methods can comprise calculating a time delay between the separating of the first ribbon portion and the sensing of the thickness. Methods can comprise directing a laser beam at a laser power based on the time delay toward a second location of the second ribbon portion corresponding to the first location of the first ribbon portion to decrease a viscosity at the second location and attain the target thickness at the second location.

In some embodiments, methods can comprise generating a predicted thickness profile of the ribbon of glass-forming material comprising predicted thicknesses at the plurality of locations.

In some embodiments, identifying the first location can comprise comparing the predicted thickness profile with the thicknesses sensed at the plurality of locations.

In some embodiments, methods can comprise generating a second thickness profile of the second ribbon portion based on the comparison between the predicted thickness profile and the thickness sensed at the plurality of locations.

In some embodiments, methods can comprise identifying a third location of the plurality of locations in which a third corresponding thickness at the third location is less than the target thickness.

In some embodiments, methods can comprise directing a cooling fluid toward a fourth location of the second ribbon portion corresponding to the third location of the first ribbon portion to increase a viscosity at the fourth location and attain the target thickness at the fourth location.

In some embodiments, methods of manufacturing a glass ribbon can comprise moving a ribbon of glass-forming material along a travel path in a travel direction. Methods can comprise sensing a thickness of the ribbon of glass-forming material at a plurality of locations of the ribbon of glass-forming material. Methods can comprise identifying one or more of a location of the plurality of locations in which a corresponding thickness at the location exceeds a target thickness or a second location of the plurality of locations in which a second corresponding thickness at the second location is less than the target thickness. Methods can comprise correlating a rate of thickness change and a thickness difference between the corresponding thickness and the target thickness to a laser power when the corresponding thickness at the location exceeds the target thickness. Methods can comprise directing one or more of a laser beam at the laser power toward the ribbon of glass-forming material to decrease a viscosity at the location and attain the target thickness at the location, or a cooling fluid toward the ribbon of glass-forming material to increase a viscosity at the second location and attain the target thickness at the second location.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates example embodiments of a glass manufacturing apparatus in accordance with embodiments of the disclosure;

FIG. 2 illustrates a perspective cross-sectional view of the glass manufacturing apparatus along line 2-2 of FIG. 1 in accordance with embodiments of the disclosure;

FIG. 3 illustrates a thickness sensor and a control device of the glass manufacturing apparatus for sensing and controlling a thickness of a ribbon of glass-forming material;

FIG. 4 illustrates a thickness sensor sensing a thickness of a first portion of a ribbon of glass-forming material after the first portion has been separated from a second portion;

FIG. 5 illustrates a control scheme for sensing and controlling a thickness of a ribbon of glass-forming material;

FIG. 6 illustrates a thickness sensor sensing a thickness of the ribbon of glass-forming material and an adjustment apparatus that heats and/or cools a portion of the ribbon of glass-forming material; and

FIG. 7 illustrates a thickness sensor sensing a thickness of a first portion of a ribbon of glass-forming material after the first portion has been separated from a second portion and an adjustment apparatus that heats and/or cools a portion of the ribbon of glass-forming material.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

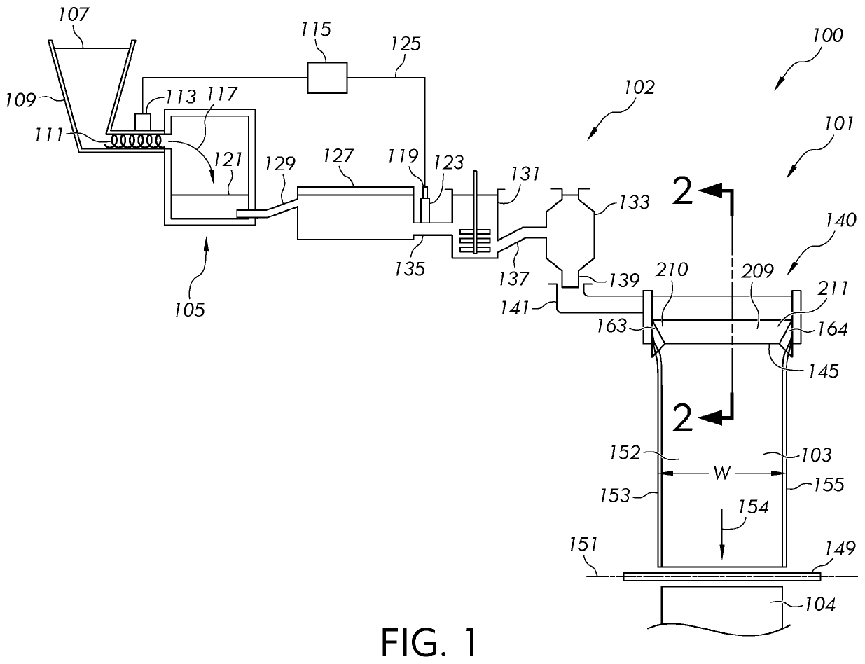

The present disclosure relates to a glass manufacturing apparatus and methods for producing a glass ribbon. Methods and apparatus for producing a glass ribbon will now be described by way of example embodiments for producing a glass ribbon from a ribbon of glass-forming material. As schematically illustrated in FIG. 1, in some embodiments, an exemplary glass manufacturing apparatus 100 can comprise a glass melting and delivery apparatus 102 and a forming apparatus 101 comprising a forming vessel 140 designed to produce a ribbon of glass-forming material 103 from a quantity of molten material 121. In some embodiments, the ribbon of glass-forming material 103 can comprise a central portion 152 positioned between opposite edge portions (e.g., edge beads) formed along a first outer edge 153 and a second outer edge 155 of the ribbon of glass-forming material 103, wherein a thickness of the edge portions can be greater than a thickness of the central portion. Additionally, in some embodiments, a separated glass ribbon 104 can be separated from the ribbon of glass-forming material 103 along a separation path 151 by a glass separator 149 (e.g., scribe, score wheel, diamond tip, laser, etc.).

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery chamber 133 that can be located downstream from the mixing chamber 131. In some embodiments, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In some embodiments, molten material 121 can be gravity fed from the mixing chamber 131 to the delivery chamber 133 by way of the third connecting conduit 137. For example, in some embodiments, gravity can drive the molten material 121 through an interior pathway of the third connecting conduit 137 from the mixing chamber 131 to the delivery chamber 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure, for example, a forming vessel with a wedge for fusion drawing the glass ribbon, a forming vessel with a slot to slot draw the glass ribbon, or a forming vessel provided with press rolls to press roll the glass ribbon from the forming vessel. In some embodiments, the forming apparatus 101 can comprise a sheet redraw, for example, with the forming apparatus 101 as part of a redraw process. For example, the glass ribbon 104, which can comprise a thickness, may be heated up and redrawn to achieve a thinner glass ribbon 104 comprising a smaller thickness. By way of illustration, the forming vessel 140 shown and disclosed below can be provided to fusion draw molten material 121 off a bottom edge, defined as a root 145, of a forming wedge 209 to produce the ribbon of glass-forming material 103. For example, in some embodiments, the molten material 121 can be delivered from the inlet conduit 141 to the forming vessel 140. The molten material 121 can then be formed into the ribbon of glass-forming material 103 based, in part, on the structure of the forming vessel 140. For example, as shown, the molten material 121 can be drawn off the bottom edge (e.g., root 145) of the forming vessel 140 along a draw path extending in a travel direction 154 of the glass manufacturing apparatus 100. In some embodiments, edge directors 163, 164 can direct the molten material 121 off the forming vessel 140 and define, in part, a width “W” of the ribbon of glass-forming material 103. In some embodiments, the width “W” of the ribbon of glass-forming material 103 extends between the first outer edge 153 of the ribbon of glass-forming material 103 and the second outer edge 155 of the ribbon of glass-forming material 103.

In some embodiments, the width “W” of the ribbon of glass-forming material 103, which extends between the first outer edge 153 of the ribbon of glass-forming material 103 and the second outer edge 155 of the ribbon of glass-forming material 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in further embodiments. For example, in some embodiments, the width “W” of the ribbon of glass-forming material 103 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

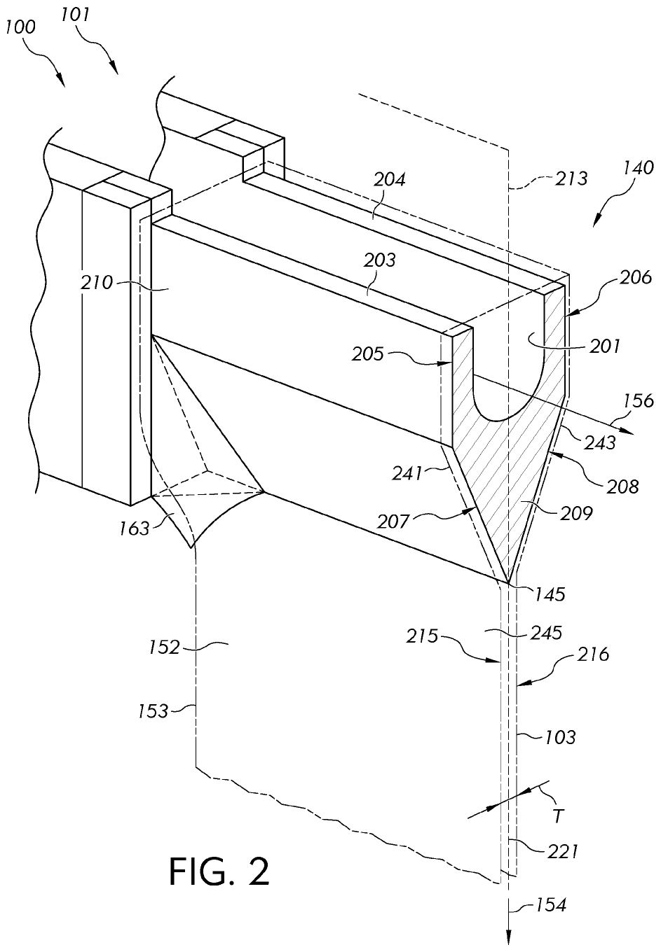

FIG. 2 shows a cross-sectional perspective view of the forming apparatus 101 (e.g., forming vessel 140) along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the travel direction 154 to intersect along the root 145 of the forming vessel 140. The root 145 defines a bottom of the forming wedge 209 at which the downwardly inclined converging surface portions 207, 208 intersect to form a point. A draw plane 213 of the glass manufacturing apparatus 100 can extend through the root 145 along the travel direction 154. In some embodiments, the ribbon of glass-forming material 103 can be drawn in the travel direction 154 along the draw plane 213. As shown, the draw plane 213 can bisect the forming wedge 209 through the root 145 although, in some embodiments, the draw plane 213 can extend at other orientations relative to the root 145. In some embodiments, methods of manufacturing a glass ribbon can comprise moving the ribbon of glass-forming material 103 along a travel path 221 in the travel direction 154, wherein the travel path 221 may be co-planar with the draw plane 213.

Additionally, in some embodiments, the molten material 121 can flow in a direction 156 into and along the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. For example, methods of manufacturing a glass ribbon can comprise flowing a first stream 241 of glass-forming material over a first weir 203 of the forming wedge 209 and flowing a second stream 243 of glass-forming material over a second weir 204 of the forming wedge 209. The first stream 241 of glass-forming material and the second stream 243 of glass-forming material can flow along the downwardly inclined converging surface portions 207, 208 of the forming wedge 209 to be drawn off the root 145 of the forming vessel 140. In some embodiments, methods of manufacturing a glass ribbon can comprise fusing the first stream 241 of glass-forming material and the second stream 243 of glass-forming material to form a fused ribbon 245. For example, the first stream 241 and the second stream 243 can converge and fuse at the root 145. In some embodiments, the fused ribbon 245 can be drawn off the root 145 in the draw plane 213 along the travel direction 154. In some embodiments, the ribbon of glass-forming material 103 can comprise the first stream 241 of glass-forming material and the second stream 243 of glass-forming material upstream of the root 145 relative to the travel direction 154 prior to fusing and may comprise the fused ribbon 245 that has been drawn off the root 145 downstream from the forming wedge 209 relative to the travel direction 154. The ribbon of glass-forming material 103 can comprise at least one state of material based on a vertical location of the ribbon of glass-forming material 103. For example, at one location, the ribbon of glass-forming material 103 can comprise the viscous molten material 121, and at another location, the ribbon of glass-forming material 103 can comprise an amorphous solid in a glassy state (e.g., a glass ribbon).

The ribbon of glass-forming material 103 comprises a first major surface 215 and a second major surface 216 facing opposite directions and defining a thickness “T” (e.g., average thickness) of the ribbon of glass-forming material 103 along an axis normal to one or both of the first major surface 215 or the second major surface 216. In some embodiments, the thickness “T’ of the ribbon of glass-forming material 103 can be less than or equal to about 2 millimeters (mm), less than or equal to about 1 millimeter, less than or equal to about 0.5 millimeters, for example, less than or equal to about 300 micrometers (nm), less than or equal to about 200 micrometers, or less than or equal to about 100 micrometers, although other thicknesses may be provided in further embodiments. For example, in some embodiments, the thickness “T’ of the ribbon of glass-forming material 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the ribbon of glass-forming material 103 can comprise a variety of compositions, for example, borosilicate glass, alumino-borosilicate glass, alkali-containing glass, or alkali-free glass, alkali aluminosilicate glass, alkaline earth aluminosilicate glass, soda-lime glass, etc.

In some embodiments, the glass separator 149 (see FIG. 1) can separate the glass ribbon 104 from the ribbon of glass-forming material 103 along the separation path 151 to provide a plurality of separated glass ribbons 104 (i.e., a plurality of sheets of glass). According to other embodiments, a longer portion of the glass ribbon 104 may be coiled onto a storage roll. The separated glass ribbon can then be processed into a desired application, e.g., a display application. For example, the separated glass ribbon can be used in a wide range of display applications, comprising liquid crystal displays (LCDs), electrophoretic displays (EPD), organic light emitting diode displays (OLEDs), plasma display panels (PDPs), touch sensors, photovoltaics, and other electronic displays.

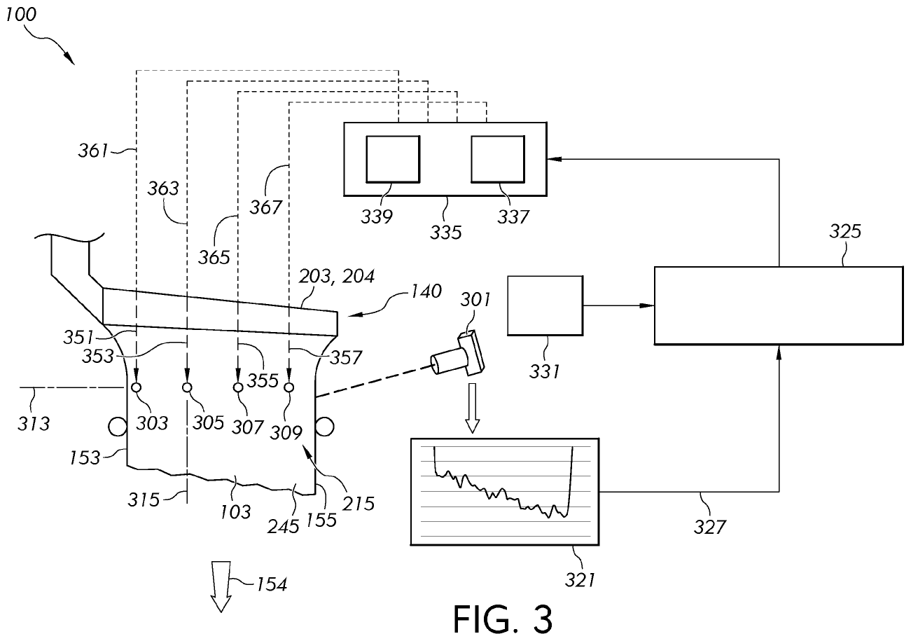

FIG. 3 illustrates a schematic view of the forming vessel 140. In some embodiments, the glass manufacturing apparatus 100 can comprise a thickness sensor 301 that can measure the thickness (e.g., thickness “T” illustrated in FIG. 2) of the ribbon of glass-forming material 103. For example, the thickness may be measured between the first major surface 215 and the second major surface 216 of the ribbon of glass-forming material 103 (e.g., perpendicular to the width “W” of the ribbon of glass-forming material 103 extending between the first outer edge 153 and the second outer edge 155 illustrated in FIG. 1). In some embodiments, the thickness sensor 301 can sense a thickness of the ribbon of glass-forming material 103 at a bottom of the forming vessel 140, for example, downstream from the root 145 of the forming vessel 140 relative to the travel direction 154. In some embodiments, the thickness sensor 301 can comprise a laser-based thickness measurement device.

In some embodiments, the thickness sensor 301 can sense the thickness of the ribbon of glass-forming material 103 at one or more locations, for example, at a first location 303, a second location 305, a third location 307, a fourth location 309, etc. In some embodiments, methods of manufacturing a glass ribbon can comprise sensing the thickness of the ribbon of glass-forming material 103 at the plurality of locations (e.g., the first location 303, the second location 305, the third location 307, the fourth location 309, etc.) of the ribbon of glass-forming material 103. Sensing the thickness of the ribbon of glass-forming material 103 may occur at the plurality of locations spaced apart along a first axis 313 that may be substantially perpendicular to the travel direction 154. For example, the first axis 313 may extend across the ribbon of glass-forming material 103 (e.g., between the first outer edge 153 and the second outer edge 155) along a direction that may be substantially parallel to the first major surface 215 and/or the second major surface 216 of the ribbon of glass-forming material 103. In some embodiments, a distance separating the first location 303 from the first outer edge 153 may be less than a distance separating the second location 305, the third location 307, and/or the fourth location 309 from the first outer edge 153. In some embodiments, a distance separating the fourth location 309 from the second outer edge 155 may be less than a distance separating the first location 303, the second location 305, and/or the third location 307 from the second outer edge 155. In some embodiments, the second location 305 and the third location 307 may be located between the first location 303 and the fourth location 309.

The glass manufacturing apparatus 100 is not limited to sensing the thickness of the ribbon of glass-forming material 103 along a single axis, for example, the first axis 313. Rather, in some embodiments, the thickness sensor 301 and/or an additional thickness sensor can sense the thickness of the ribbon of glass-forming material 103 along one or more axes that may be angled relative to the first axis 313, for example, along a second axis 315 that may be substantially perpendicular to the first axis 313 and substantially parallel to the travel direction 154. The second axis 315 may intersect the second location 305. In some embodiments, the thickness sensor 301 and/or an additional thickness sensor can sense the thickness of the ribbon of glass-forming material 103 along one or more axes that may be substantially parallel to the first axis 313 and/or to the second axis 315.

In some embodiments, the thickness sensor 301 can generate a thickness profile 321 corresponding to the thicknesses sensed by the thickness sensor 301 at the plurality of locations, for example, the first location 303, the second location 305, the third location 307, and the fourth location 309. The thickness sensor 301 can periodically and/or continuously sense the thickness of the ribbon of glass-forming material 103. For example, in some embodiments, the thickness sensor 301 can continuously sense the thickness at the plurality of locations (e.g., without interruptions or gaps), such that the thickness sensor 301 can generate an updated thickness profile 321 corresponding to a real-time thickness of the ribbon of glass-forming material 103. The real-time thickness of the ribbon of glass-forming material 103 can represent the instantaneous thickness at the time that the ribbon of glass-forming material 103 is measured, whereupon the thickness of the ribbon of glass-forming material 103 may be immediately transmitted to a device (e.g., a control device 325) for processing. In some embodiments, the thickness sensor 301 can periodically sense the thickness at the plurality of locations, for example, by sensing the thickness of the ribbon of glass-forming material 103, followed by waiting a predetermined period of time without sensing the thickness, followed by sensing the thickness again, etc. The thickness sensor 301 can therefore generate an updated thickness profile 321 that may not correspond to the real-time thickness at the plurality of locations. In some embodiments, the thickness sensor 301 can sense the thickness at a static location relative to the forming vessel 140. For example, in some embodiments, the thickness sensor 301 can sense the thickness at the plurality of locations 303, 305, 307, or 309, wherein the first axis 313 and, thus, the plurality of locations 303, 305, 307, or 309, may be located a static and non-changing distance from the root 145.

In some embodiments, the glass manufacturing apparatus 100 can comprise the control device 325 that may be coupled to the thickness sensor 301. The control device 325 can comprise, for example, a computer, a computer-like device, a programmable logic controller, etc. In some embodiments, the control device 325 may be configured to (e.g., programmed to, encoded to, designed to, and/or made to) effectuate a change in the thickness of the ribbon of glass-forming material 103 based on the thickness sensed by the thickness sensor 301. For example, the thickness sensor 301 can be in communication with the control device 325 by way of a communication line 327 (e.g., wired, wireless, etc.). The thickness profile 321 can be transmitted from the thickness sensor 301 to the control device 325 through the communication line 327. In some embodiments, a target thickness profile 331 can be transmitted to the control device 325. The target thickness profile 331 can comprise an operating range of target thicknesses of the ribbon of glass-forming material 103. For example, the target thickness profile 331 can comprise a first target thickness at the first location 303, a second target thickness at the second location 305, a third target thickness at the third location 307, and a fourth target thickness at the fourth location 309.

In some embodiments, the glass manufacturing apparatus 100 can comprise a laser apparatus 335 that can emit a laser beam to increase a temperature and decrease a viscosity of a portion of the ribbon of glass-forming material 103 in a viscous state, thereby altering the thickness at the portion of the ribbon of glass-forming material 103 that is impinged by the laser beam. In some embodiments, the laser apparatus 335 can comprise a laser generator 337. The laser generator 337 can generate and emit the laser beam. In some embodiments, the laser generator 337 can comprise a high-intensity infrared laser generator, for example, a carbon dioxide (CO₂) laser generator. The laser generator 337 can produce a laser beam that comprises a wavelength and power that are sufficient to increase the temperature and decrease the viscosity of the portion of the ribbon of glass-forming material 103 that is impinged by the laser beam. In some embodiments, to control a direction at which the laser beam from the laser generator 337 is oriented, the laser apparatus 335 can comprise a beam-directing apparatus 339. The beam-directing apparatus 339 can comprise a reflecting surface, for example, a mirror. The beam-directing apparatus 339 can be coupled to a movement apparatus that can move the beam-directing apparatus 339, for example, by rotating the beam-directing apparatus 339 and/or translating the beam-directing apparatus 339.

The beam-directing apparatus 339 can receive the laser beam from the laser generator 337 and direct (e.g., reflect when the beam-directing apparatus 339 comprises a mirror) the laser beam toward the ribbon of glass-forming material 103. For example, in some embodiments, the beam-directing apparatus 339 can direct the laser beam toward one or more of the first location 303, the second location 305, the third location 307, and/or the fourth location 309. In some embodiments, the beam-directing apparatus 339 can direct a first laser beam 351 toward the first location 303, in which the first laser beam 351 may impinge upon the ribbon of glass-forming material 103 at a location below the root 145 of the forming vessel 140. In some embodiments, the beam-directing apparatus 339 can direct a second laser beam 353 toward the second location 305, in which the second laser beam 353 may impinge upon the ribbon of glass-forming material 103 at a location below the root 145 of the forming vessel 140. In some embodiments, the beam-directing apparatus 339 can direct a third laser beam 355 toward the third location 307, in which the third laser beam 355 may impinge upon the ribbon of glass-forming material 103 at a location below the root 145 of the forming vessel 140. In some embodiments, the beam-directing apparatus 339 can direct a fourth laser beam 357 toward the fourth location 309, in which the fourth laser beam 357 may impinge upon the ribbon of glass-forming material 103 at a location below the root 145 of the forming vessel 140. In some embodiments, the beam-directing apparatus 339 can be moved based on control instructions that may be provided from the control device 325 to the laser apparatus 335, wherein the control instructions may instruct the beam-directing apparatus 339 to direct one or more of the laser beams 351, 353, 355, or 357 to a specific location.

The beam-directing apparatus 339 is not limited to reflecting a laser beam toward a location below the root 145 of the forming vessel 140 relative to the travel direction 154, but, rather, in some embodiments, the beam-directing apparatus 339 can direct a laser beam above the root 145, for example, toward the first weir 203 and/or the second weir 204. In some embodiments, the beam-directing apparatus 339 can direct a first laser beam 361 toward the first weir 203 and/or the second weir 204 at a location that corresponds to the first location 303. As used herein, a location that corresponds to the first location 303 may comprise a location of the first stream 241 of glass-forming material and/or the second stream 243 of glass-forming material upstream of the first location 303 relative to the travel direction 154 as the first stream 241 and/or the second stream 243 exit the forming vessel 140 that intersects the first location 303. In some embodiments, the beam-directing apparatus 339 can direct a second laser beam 363 toward the first weir 203 and/or the second weir 204 at a location that corresponds to the second location 305. In some embodiments, the beam-directing apparatus 339 can direct a third laser beam 365 toward the first weir 203 and/or the second weir 204 at a location that corresponds to the third location 305. In some embodiments, the beam-directing apparatus 339 can direct a fourth laser beam 367 toward the first weir 203 and/or the second weir 204 at a location that corresponds to the fourth location 309.

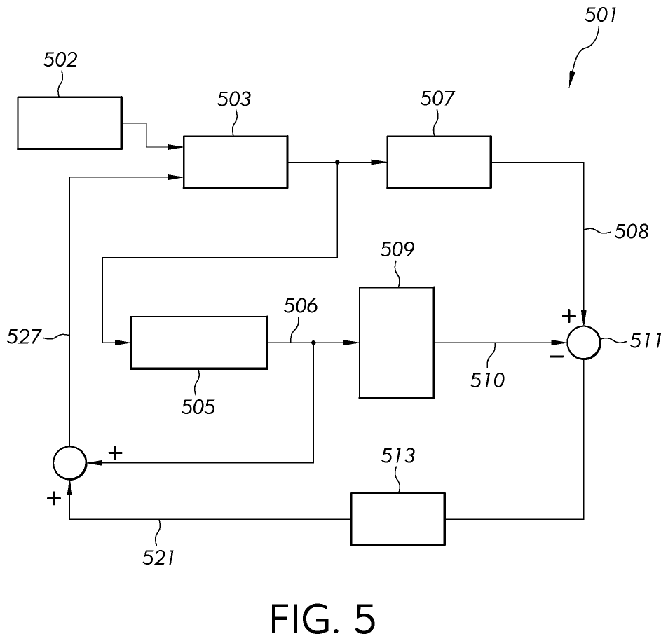

In some embodiments, the control device 325 can compare the thickness profile 321 to the target thickness profile 331 to determine whether a corresponding thickness at one of the locations 303, 305, 307, or 309 exceeds a target thickness of the target thickness profile 331. For example, the control device 325 can receive the thickness profile 321, which may comprise the thicknesses of the ribbon of glass-forming material 103 at the first location 303, the second location 305, the third location 307, and the fourth location 309 as measured by the thickness sensor 301. The control device 325 can compare the thickness at the locations 303, 305, 307, and/or 309 to the target thickness profile 331, for example, a target thickness of the locations 303, 305, 307, and/or 309, respectively. In some embodiments, methods of manufacturing a glass ribbon can comprise identifying a location of the plurality of locations 303, 305, 307, and/or 309 in which a corresponding thickness at the location exceeds a target thickness (e.g., from the target thickness profile 331). The control device 325 can determine the thickness difference between a measured thickness at one of the locations 303, 305, 307, or 309 and a target thickness at that location 303, 305, 307, or 309. In addition, as described relative to FIG. 5, the control device 325 can determine the appropriate laser power of the laser beam 351, 353, 355, 357, 361, 363, 365, and/or 367 to cause a decrease in viscosity at the location and attain the target thickness at the location.

The control device 325 can transmit instructions comprising the appropriate laser power and the location to the laser apparatus 335. In some embodiments, methods of manufacturing a glass ribbon can comprise directing the laser beam 351, 353, 355, 357, 361, 363, 365, and/or 367 toward the ribbon of glass-forming material 103 to decrease the viscosity at the location and attain the target thickness at the location. For example, in some embodiments, a measured thickness at the first location 303 of the ribbon of glass-forming material 103 may exceed the target thickness at the first location 303. The control device 325 can determine the difference between the measured thickness and the target thickness at the first location 303 and correlate a rate of thickness change to a laser power. In some embodiments, the rate of thickness change and the laser power can be provided to the control device 325 and may be based on actual observed impacts of thickness changes based on a particular laser power. In some embodiments, the rate of thickness change and the laser power provided to the control device 325 can be based on a mathematical model. In some embodiments, the model can be updated with actual observed impacts based on different laser powers. The control device 325 can cause the laser generator 337 to direct the first laser beam 351 toward the first location 303 at the laser power. In response, a viscosity at the first location 303 may decrease which can cause the thickness at the first location 303 to decrease until the target thickness is attained at the first location 303. In some embodiments, methods of manufacturing a glass ribbon can comprise directing the laser beam 361, 363, 365, and/or 367 toward one or more of the first stream 241 of glass-forming material flowing over the first weir 203, the second stream 243 of glass-forming material flowing over the second weir 204, or the fused ribbon 245. For example, the control device 325 can trigger the laser generator 337 to direct the first laser beam 361 toward the first stream 241 of glass-forming material flowing over the first weir 203 and/or toward the second stream 243 of glass-forming material flowing over the second weir 204. A viscosity of the first stream 241 of glass-forming material or the second stream 243 of glass-forming material may decrease, which can cause the thickness at the first location 303 to decrease until the target thickness is attained at the first location 303.

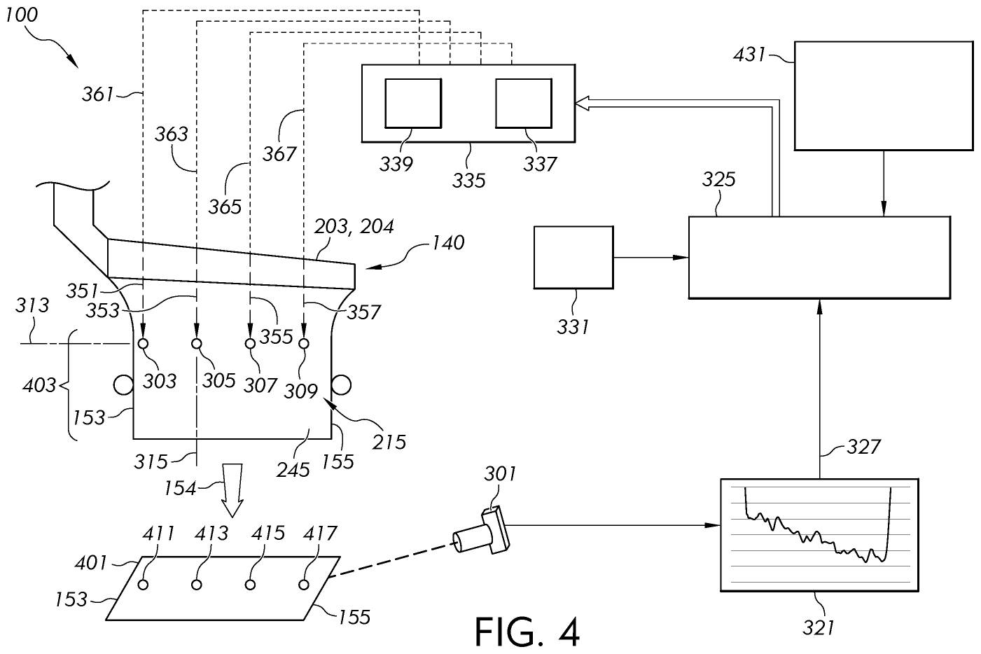

Referring to FIG. 4, in some embodiments, the thickness of the ribbon of glass-forming material 103 can be sensed after a first ribbon portion 401 has been separated from a second ribbon portion 403. For example, in some embodiments, methods of manufacturing a glass ribbon can comprise separating the first ribbon portion 401 of the ribbon of glass-forming material 103 from the second ribbon portion 403 of the ribbon of glass-forming material 103 prior to sensing a thickness of the first ribbon portion 401. As the ribbon of glass-forming material 103 moves in the travel direction 154, the first ribbon portion 401 can be separated from the second ribbon portion 403, for example, by the glass separator 149 of FIG. 1. In some embodiments, the first ribbon portion 401 can be transported to a remote location following the separation, for example, to a location where the first ribbon portion 401 can be inspected and a thickness can be measured.

Following the separation, methods of manufacturing a glass ribbon can comprise sensing a thickness at a plurality of locations of the first ribbon portion 401. For example, the thickness sensor 301 can sense the thickness of the first ribbon portion 401 at a first location 411, a second location 413, a third location 415, and a fourth location 417 of the first ribbon portion 401, although in further embodiments, the thickness can be sensed in more than four locations while in still further embodiments, the thickness can be sensed in fewer than four locations. In some embodiments, sensing the thickness of the ribbon of glass-forming material 103 can occur in the first ribbon portion 401 of the ribbon of glass-forming material 103 after separating the first ribbon portion 401 from the second ribbon portion 403 of the ribbon of glass-forming material 103. In some embodiments, the thickness of the first ribbon portion 401 can be sensed immediately following the separation of the first ribbon portion 401 from the second ribbon portion 403, such that a time delay between the separation of the first ribbon portion 401 and the sensing of the thickness of the first ribbon portion 401 may be short. In some embodiments, the time delay may be longer, for example, when the thickness of the first ribbon portion 401 is not sensed immediately following the separation, but, rather, after a period of time has passed following the separation. For example, a time delay may result from transporting the first ribbon portion 401 from the location where the first ribbon portion 401 is separated to the remote location where the first ribbon portion 401 can be inspected and a thickness can be measured.

In some embodiments, a position of the first location 411, the second location 413, the third location 415, and/or the fourth location 417 relative to the first outer edge 153 and the second outer edge 155 of the first ribbon portion 401 can correspond to a position of the first location 303, the second location 305, the third location 307, and/or the fourth location 309, respectively, relative to the first outer edge 153 and the second outer edge 155 of the second ribbon portion 403. For example, the first location 411 can be spaced a first distance from the first outer edge 153 of the first ribbon portion 401, and the first location 303 can be spaced the first distance from the first outer edge 153 of the second ribbon portion 403. In some embodiments, the fourth location 417 can be spaced a second distance from the second outer edge 155 of the first ribbon portion 401, and the fourth location 309 can be spaced the second distance from the second outer edge 155 of the second ribbon portion 403. In some embodiments, a distance separating the plurality of locations 411, 413, 415, or 417 of the first ribbon portion 401 can match a distance separating the plurality of locations 303, 305, 307, or 309 of the second ribbon portion 403. Accordingly, a thickness at the plurality of locations 411, 413, 415, or 417 of the first ribbon portion 401 can be altered by impinging the laser beam 351, 353, 355, or 357 at the plurality of locations 303, 305, 307, or 309 of the second ribbon portion 403 and/or by impinging the laser beam 361, 363, 365, or 367 at the first stream 241 flowing over the first weir 203 and/or the second stream 243 flowing over the second weir 204.

In some embodiments, methods of manufacturing a glass ribbon can comprise identifying a first location of the plurality of locations 411, 413, 415, or 417 in which a corresponding thickness at the first location 303 exceeds a target thickness. For example, in some embodiments, the glass manufacturing apparatus 100 of FIG. 4 can comprise the thickness sensor 301, the control device 325, and the laser apparatus 335, which may be substantially similar to the thickness sensor 301, the control device 325, and the laser apparatus 335 of FIG. 3. The thickness sensor 301 can sense the thickness of the plurality of locations 411, 413, 415, or 417 of the first ribbon portion 401, and generate the thickness profile 321. In some embodiments, the control device 325 can compare the measured thicknesses of the thickness profile 321 with the target thickness profile 331 to identify whether any of the measured thicknesses of the locations 411, 413, 415, or 417 exceed a target thickness. In addition, in some embodiments, the control device 325 can calculate the time delay between the separating of the first ribbon portion 401 (e.g., from the second ribbon portion 403) and the sensing of the thickness. For example, a period of time may pass between separating the first ribbon portion 401 and sensing the thickness with the thickness sensor 301 at the locations 411, 413, 415, or 417, wherein the period of time may comprise, in part, the time it takes to transport the first ribbon portion 401 to a remote location.

In some embodiments, methods of manufacturing a glass ribbon can comprise directing the laser beam 351, 353, 355, 357, 361, 363, 365, and/or 367 at a laser power based on the time delay toward a second location 303, 305, 307, and/or 309 of the second ribbon portion 403 corresponding to the first location 411, 413, 415, and/or 417, respectively, of the first ribbon portion 401 to decrease a viscosity at the second location 303, 305, 307, and/or 309 and attain the target thickness at the second location 303, 305, 307, and/or 309. In some embodiments, the laser apparatus 335 can direct one or more of the laser beams 351, 353, 355, 357, 361, 363, 365, or 367 toward the ribbon of glass-forming material 103 in a similar manner as described in FIG. 3. For example, in some embodiments, the laser apparatus 335 can direct one or more of the laser beams 361, 363, 365, or 367 toward one or more of the first stream 241 of glass-forming material over the first weir 203 or the second stream 243 of glass-forming material over the second weir 204. In some embodiments, the laser apparatus 335 can direct one or more of the laser beams 351, 353, 355, or 357 toward the fused ribbon 245.

In some embodiments, due to the time delay between the separation of the first ribbon portion 401 from the second ribbon portion 403 and the sensing of the thickness of the first ribbon portion 401, the effects of the laser beam 351, 353, 355, 357, 361, 363, 365, and/or 367 may not be immediately noticed by the thickness sensor 301. For example, in FIG. 3, in which the thickness sensor 301 may be located in proximity to and downstream from the locations 303, 305, 307, and/or 309 relative to the travel direction 154, thickness changes caused by the laser beam 351, 353, 355, 357, 361, 363, 365, and/or 367 may be sensed by the thickness sensor 301 soon after the laser beam 351, 353, 355, 357, 361, 363, 365, and/or 367 impinges upon the ribbon of glass-forming material 103. However, in FIG. 4, the time delay caused by the separation of the first ribbon portion 401 may result in a time delay between when the laser beam 351, 353, 355, 357, 361, 363, 365, and/or 367 impinges upon the second ribbon portion 403, and when the resulting thickness changes are sensed by the thickness sensor 301. As such, in some embodiments, the control device 325 can incorporate the time delay into the instructions transmitted to the laser apparatus 335. For example, in the absence of the control device 325 incorporating the time delay, the laser beam 351, 353, 355, 357, 361, 363, 365, and/or 367 may be directed to impinge upon the second ribbon portion 403 at a power and/or for a time that is greater than desired to achieve a target thickness change, thus causing the thickness change to overshoot the target thickness profile 331.

In some embodiments, to direct the laser beam 351, 353, 355, 357, 361, 363, 365, and/or 367 at an appropriate laser power based on the time delay, a time delay profile 431 can be transmitted to the control device 325. For example, the time delay profile 431 can comprise an amount of time that has elapsed between the separation of the first ribbon portion 401 from the second ribbon portion 403 and the sensing of the thickness of the first ribbon portion 401 and/or an amount of time that has elapsed between the impingement of the laser beam 351, 353, 355, 357, 361, 363, 365, and/or 367 on the second ribbon portion 403, and the subsequent sensing of the thickness of the second ribbon portion 403. In some embodiments, the amount of time that has elapsed can comprise an actual observed time, for example, as measured by a timing device. In some embodiments, the amount of time that has elapsed can be provided based on a mathematical model, for example, one or both of a predicted amount of time that has elapsed (e.g., between the separating or impingement and the sensing) or an average amount of time that has elapsed (e.g., between the separating or impingement and the sensing) over one or more cycles. It may be beneficial to provide the time delay profile 431 to the control device 325 for several reasons. For example, the time delay can represent an amount of time between when the laser beam 351, 353, 355, 357, 361, 363, 365, and/or 367 is directed toward the ribbon of glass-forming material 103 (e.g., which can increase the temperature and decrease the viscosity of a location of the ribbon of glass-forming material 103, thus changing a thickness at that location) and when the resulting thickness change is sensed by the thickness sensor 301. With reference to FIG. 3, due to the thickness sensor 301 measuring the thickness at a location that is in close proximity to the location at which the laser beam 351, 353, 355, 357, 361, 363, 365, and/or 367 impinges upon the ribbon of glass-forming material 103, the time delay may be negligible, such that the thickness sensor 301 may sense thickness changes nearly immediately after the application of the laser beam 351, 353, 355, 357, 361, 363, 365, and/or 367. With reference to FIG. 4, the time delay between the separation of the first ribbon portion 401 and the thickness sensing by the thickness sensor 301 can increase the time between when the laser beam 351, 353, 355, 357, 361, 363, 365, and/or 367 impinges upon the ribbon of glass-forming material 103 and when the resulting thickness changes in the first ribbon portion 401 may be sensed by the thickness sensor 301. As such, by incorporating the time delay profile 431, the control device 325 may achieve a more accurate thickness change and limit the likelihood of overshooting the target thickness profile 331.

Referring to FIG. 5, a schematic flow diagram 501 illustrates methods of manufacturing a glass ribbon using the control device 325. In some embodiments, the control device 325 can account for the impact of the laser beam 351, 353, 355, 357, 361, 363, 365, and/or 367 on the magnitude change of thickness of the ribbon of glass-forming material 103 and the speed of the thickness change. For example, the impact of the laser apparatus 335 on the ribbon of glass-forming material 103 can be modeled with a gain matrix that correlates a power of the laser beam 351, 353, 355, 357, 361, 363, 365, and/or 367 to a thickness change at a location of the ribbon of glass-forming material 103. In some embodiments, by modeling the impact of the laser apparatus 335 with the gain matrix, the thickness change caused by the laser beam 351, 353, 355, 357, 361, 363, 365, and/or 367 at a location at which the laser beam 351, 353, 355, 357, 361, 363, 365, and/or 367 impinges the ribbon of glass-forming material 103, along with surrounding locations that may not be impinged by the laser beam 351, 353, 355, 357, 361, 363, 365, and/or 367, can be modeled. The gain matrix may be represented by the variable K_{m×p} and can have a dimension m×p, wherein m is a variable representing a total number of locations (e.g., locations 303, 305, 307, and/or 309 in FIG. 3 and/or locations 411, 413, 415, and/or 417 in FIG. 4) at which a thickness may be measured by the thickness sensor 301. The variable p can represent a total number of locations (e.g., locations 303, 305, 307, and/or 309 in FIGS. 3-4) at which the laser beam 351, 353, 355, 357, 361, 363, 365, and/or 367 impinges upon the ribbon of glass-forming material 103. In some embodiments, variable p can incorporate the area of the laser beam 351, 353, 355, 357, 361, 363, 365, and/or 367 impinging upon the ribbon of glass-forming material 103, a resolution of the laser beam 351, 353, 355, 357, 361, 363, 365, and/or 367 as determined by the beam-directing apparatus 339, and the movement speed of the laser beam 351, 353, 355, 357, 361, 363, 365, and/or 367 (e.g., as moved by the beam-directing apparatus 339) across the ribbon of glass-forming material 103.

In some embodiments, a response to changes in the power of the laser beam 351, 353, 355, 357, 361, 363, 365, and/or 367 may be modeled. For example, a process model can be plotted that relates a laser power of the laser beam 351, 353, 355, 357, 361, 363, 365, and/or 367 to a thickness change at a location of the ribbon of glass-forming material 103 along with a time delay between the application of the laser beam 351, 353, 355, 357, 361, 363, 365, and/or 367 to when the thickness change is achieved. In some embodiments, if the control device 325 identifies one or more of the plurality of locations 303, 305, 307, or 309 as comprising a thickness that exceeds the target thickness, the control device 325 can determine an appropriate laser power of the laser beam 351, 353, 355, 357, 361, 363, 365, and/or 367 and cause the laser beam 351, 353, 355, 357, 361, 363, 365, and/or 367 to be directed toward the ribbon of glass-forming material 103. For example, in some embodiments, the process model can comprise a thickness profile that determines an impact of the laser beam 351, 353, 355, 357, 361, 363, 365, and/or 367 at locations adjacent to the location at which the laser beam 351, 353, 355, 357, 361, 363, 365, and/or 367 impinges upon the ribbon of glass-forming material 103. For example, with reference to FIGS. 3-4, if the second laser beam 353 impinges upon the second location 305, the process model can comprise a thickness profile of thicknesses of the second location 305, along with adjacent locations (e.g., the first location 303, the third location 307, etc.) that may also experience a thickness change. In some embodiments, a dynamic process model may be obtained by one or more of first principal or empirical modeling using experimental data. For example, with the empirical modeling approach, a power of the laser beam 351, 353, 355, 357, 361, 363, 365, 367 can be stepped with outputs (e.g., the thickness profile of the ribbon of glass-forming material 103) modeled for each laser power. The model can be represented by equations (1) and (2) as follows:

\dot{x}_{c}(t)=A_{c}x_{c}(t)+B_{c}u(t) (1)

y(t)=C_{c}x_{c}(t−θ) (2)

In equations (1) and (2), variable t is the time variable, represented in seconds, and variable θ is the time delay (e.g., or dead-time), represented in seconds. In some embodiments, the time delay θ can represent the amount of time for the process (e.g., the thickness of the ribbon of glass-forming material 103) to begin to change in response to an impact of the laser beam 351, 353, 355, 357, 361, 363, 365, and/or 367. For example, with reference to FIG. 4, the time delay θ can represent the amount of time between the impact of the laser beam 351, 353, 355, 357, 361, 363, 365, and/or 367 and the thickness sensed by the thickness sensor 301. The variable \dot{x}_{c} is the state vector and can represent a vector of the thickness locations at different locations across the ribbon of glass-forming material 103, for example, the locations 303, 305, 307, or 309 in FIG. 3 and/or the locations 411, 413, 415, or 417 in FIG. 4. The variable y is the output and can represent a vector of the measured thickness locations, for example, the thickness of locations 303, 305, 307, or 309 in FIG. 3 and/or the thickness of locations 411, 413, 415, or 417 in FIG. 4. In some embodiments, variables y and \dot{x}_{c} may comprise the same data separated in time by the time delay θ. The variable u is the input and can represent a vector of the different locations at which the laser beam 351, 353, 355, 357, 361, 363, 365, and/or 367 is applied at a laser power, for example, due to the impact of the laser beam 351, 353, 355, 357, 361, 363, 365, and/or 367. The system matrices can then be represented by equations (3), (4), and (5) as follows:

$${A}_{c} = - \frac{1}{τ} {I}_{mxm} \qquad ( 3 )$$

$${B}_{c} = - {A}_{c} {K}_{[ mxp ]} \qquad ( 4 )$$

$${C}_{c} = {I}_{mxm} \qquad ( 5 )$$

In equations (3) and (5), variable I is an m×m identity matrix. In equation (4), the variable K_{m×p} can represent the gain matrix and can have a dimension m×p, wherein m is a variable representing a total number of locations (e.g., locations 303, 305, 307, or 309 in FIG. 3 and/or locations 411, 413, 415, or 417 in FIG. 4) at which a thickness may be measured by the thickness sensor 301. The variable p can represent a total number of locations (e.g., locations 303, 305, 307, or 309 in FIGS. 3-4) at which the laser beam 351, 353, 355, 357, 361, 363, 365, and/or 367 impinges upon the ribbon of glass-forming material 103. The model (e.g., represented by equations (1) and (2)) can therefore be converted to a discrete-time space form using a standard discretization technique as represented by equations (6) and (7) as follows:

xₘ(k+1)=Aₘxₘ(k)+Bₘu(k) (6)

yₘ(k)=Cₘxₘ(k−θ) (7)

In equations (6) and (7), the variable k is a discrete time step. In some embodiments, with reference to FIG. 4, when the thickness of the first ribbon portion 401 is measured by the thickness sensor 301 after the first ribbon portion 401 is separated from the second ribbon portion 403, the discrete time step k can be a product of a process cycle time. For example, a period of time (e.g., the process cycle time) can elapse between the impingement of the laser beam 351, 353, 355, 357, 361, 363, 365, and/or 367 at a location of the ribbon of glass-forming material 103 and the thickness sensing of the location (e.g., wherein the separating and transport of the first ribbon portion 401 may occur at a time between the impingement of the laser beam 351, 353, 355, 357, 361, 363, 365, and/or 367 and the thickness sensing). In some embodiments, with reference to FIG. 3, when the thickness of the ribbon of glass-forming material 103 is measured by the thickness sensor 301 prior to separating, the discrete time step k may be shorter. For example, the discrete time step k may be shorter due to the thickness sensor 301 sensing a thickness at the locations 303, 305, 307, or 309 in close proximity to (e.g., and prior to any separation) the location at which the laser beam 351, 353, 355, 357, 361, 363, 365, 367 impinges the ribbon of glass-forming material 103.

In some embodiments, the control device 325 can account for disturbances that may affect the thickness of the ribbon of glass-forming material 103, such as, for example, inconsistent flow rate of the molten material 121 flowing in the direction 156 in FIG. 2, temperature variations, etc. In addition, or in the alternative, in some embodiments, the control device 325 can account for constraints on the laser power of the laser beam 351, 353, 355, 357, 361, 363, 365, and/or 367 such that a maximum laser power of the laser beam 351, 353, 355, 357, 361, 363, 365, and/or 367 may not be exceeded. To account for these disturbances and laser power constraints, the control device 325 can comprise a model predictive control. The model predictive control can control the thickness of the ribbon of glass-forming material 103 while satisfying one or more constraints, for example, a laser power of the laser beam 351, 353, 355, 357, 361, 363, 365, and/or 367. In some embodiments, the model predictive control can simulate the thickness of the ribbon of glass-forming material 103 into the future and calculate an action of the laser apparatus 335, for example, the laser power of the laser beam 351, 353, 355, 357, 361, 363, 365, and/or 367 and the location at which the laser beam 351, 353, 355, 357, 361, 363, 365, and/or 367 impinges the ribbon of glass-forming material 103. The model predictive control can therefore achieve a target thickness profile of the ribbon of glass-forming material 103 and maintain the target thickness profile despite the possibility of disturbances (e.g., inconsistent flow rate of the molten material 121 flowing in the direction 156 in FIG. 2, temperature variations, etc.) and/or constraints on the laser power. In some embodiments, the model predictive control can comprise a delay compensation scheme, for example, a Smith predictor, to account for the time delay θ and the discrete time step k. For example, the control device 325 can comprise a delay-free model predictive control 503 based on the discrete-time space equations (6) and (7). The delay-free model predictive control 503 can predict future behavior of the process, for example, predicted thicknesses of the ribbon of glass-forming material 103 at certain times into the future. The delay-free model predictive control 503 can receive a setpoint 502, or reference function, that can comprise target thickness ranges for the different locations 303, 305, 307, and/or 309 of the ribbon of glass-forming material 103. In some embodiments, based on the predicted future behavior, the delay-free model predictive control 503 can optimize the actions of the laser apparatus 335 (e.g., the laser power, the location of impingement, etc.). The delay-free model predictive control 503 may be represented by equations (8) and (9) as follows:

x(k+1)=Ax(k)+Bu(k) (8)

y(k)=Cx(k) (9)

In some embodiments, the delay-free model predictive control 503 can be designed, in part, by setting a target thickness profile of the locations 303, 305, 307, and/or 309 of the ribbon of glass-forming material 103 at periods of time into the future. In some embodiments, the target thickness profile of the locations 303, 305, 307, and/or 309 can be provided to the control device 325 as part of the target thickness profile 331. For example, a first target thickness range can be set for the first location 303, a second target thickness range can be set for the second location 305, a third target thickness range can be set for the third location 307, and a fourth target thickness range can be set for the fourth location 309. The target thickness ranges can be represented by variable Sin equation (10) below. Variable S can represent a matrix in which each row of matrix S comprises one of the target thickness ranges, and each column of matrix S comprises a target thickness range at a future time period. For example, one row can comprise target thickness ranges at the first location 303 over a period of time, and one column comprises a target thickness range at the first location 303 at a first time, an adjacent column comprises a target thickness range at the first location 303 at a second time after the first time, etc. In addition, variable Xin equation (10) can represent a matrix of sensed thicknesses (e.g., as sensed by the thickness sensor 301). In some embodiments, variable X can represent a matrix in which each row of matrix X can comprise a sensed thickness at one of the locations 303, 305, 307, or 309, and each column of matrix X can comprise a simulated thickness at a future time period based on equations (8) and (9). For example, one row can comprise sensed thickness at the first location 303 over a period of time, wherein one column comprises a sensed thickness at the first location 303 at a first time, an adjacent column comprises a sensed thickness at the first location 303 at a second time, etc. A quadratic cost function J may be represented by equation (10) below:

J=(S−X)^{T}Q(S−X)+U^{T}RU (10)

f(U)≤C (11)

In equation (10), the variables Q and R represent weighting matrices that can penalize a deviation between the sensed thickness and the target thickness, for example, when the sensed thicknesses (e.g., represented by matrix X) differ from the target thicknesses (e.g., represented by matrix 5), and the laser power effort (e.g., represented by matrix U), respectively. For example, the variable Q penalizes the deviation between the sensed thickness and the target thickness, while the variable R penalizes the amount of power used to drive the thickness to the target thickness. In equations (10) and (11), the variable U can represent a set of laser power moves. For example, variable U can represent a matrix, wherein each row can comprise a laser power at one of the locations 303, 305, 307, or 309, and each column of variable U can comprise a laser power at a future time period (e.g., a first column can comprise a laser power at discrete time step k, a second column can comprise a laser power at discrete time step k+1, etc.). In some embodiments, as represented by equation (11), variable U can be chosen to minimize the quadratic cost function J, for example, with the laser power (e.g., variable U) within a range from about zero to a maximum laser power rating of the laser apparatus 335. Equation (11) provides an upper and lower bound on the amount of power delivered to the laser. The algorithms can run an optimization to find the matrix U that minimizes J, such that equations (8), (9), and (10) are satisfied. Accordingly, the delay-free model predictive control 503 can determine an appropriate laser power of the laser beam 351, 353, 355, 357, 361, 363, 365, and/or 367 that may not exceed the maximum laser power rating, but may be powerful enough to cause the thickness change within a predetermined amount of time. The delay-free model predictive control 503 can therefore control the laser power and the location at which the laser beam 351, 353, 355, 357, 361, 363, 365, and/or 367 is applied at each discrete time step k. In this way, in some embodiments, methods of manufacturing a glass ribbon can comprise correlating a rate of thickness change and a thickness difference between the corresponding thickness and the target thickness to a laser power, for example, when the corresponding thickness at the location exceeds the target thickness. For example, the weighting matrices (e.g., Q and R) of equation (10) can penalize the thickness difference (e.g., the deviation between the sensed thickness and the target thickness) and the variable R can penalize the laser power effort, while the laser power moves, represented by U, which can comprise the laser power applied at the locations 303, 305, 307, or 309 in the future. In some embodiments, selecting a larger variable R can cause the algorithm to use smaller laser power moves for every sample instant k. In some embodiments, the larger variable R may be used to avoid larger and/or faster laser power moves. Similarly, selecting a smaller variable R can cause the algorithm to use larger laser power moves for every sample instant k, thus facilitating larger and more rapid laser power moves to achieve the target thickness. The rate of thickness change may be represented by equations (1) and (2), wherein the output y can represent the vector of the measured thickness locations and, thus, the rate of the thickness change in response to the input u (e.g., the laser beam applied at a laser power at a location).

In some embodiments, the control device 325 can perform a model simulation 505 based on the delay-free model predictive control 503. For example, the model simulation 505 can estimate the process behavior and simulate the state vector x(k) of equation (8) based on the delay-free model predictive control 503. In some embodiments, the model simulation 505 can produce a delay-free predicated state vector 506, which may be represented by x(k). The delay-free predicated state vector 506 can represent predicted thicknesses of the ribbon of glass-forming material 103 at the locations for one or more discrete time steps k into the future. In some embodiments, to account for the time delay of FIG. 4 (e.g., as a result of the separation occurring after the impingement of the laser beam 351, 353, 355, 357, 361, 363, 365, and/or 367 but before the thickness is measured by the thickness sensor 301), the delay-free predicated state vector 506 (e.g., x(k)) can then be subjected to a time delay 509 (e.g., time delay θ) to produce a delayed state 510, for example, x_{d}(k−θ). In some embodiments, the actual thickness (e.g., measured state vector) sensed by the thickness sensor 301 at discrete time k can be represented by a process including the time delay 507, which can produce a time delayed full system state 508 (e.g., inclusive of the actual thickness sensed by the thickness sensor 301, the time delay θ, and any potential process disturbances). The time-delayed full system state 508 (e.g., the measured state vector) may be represented by xₘ(k−θ). In some embodiments, a comparison 511 can be made between the measured state vector 508 from 507 (e.g., xₘ(k−θ)) and the predicted state vector 510 comprising the time delay 509 (e.g., x_{d}(k−θ)) can be compared, with the result represented by equation (12) below:

xₑ(k)=xₘ(k−θ)−x_{d}(k−θ) (12)

The resulting difference, xₑ (k), is the delayed state prediction error, which represents a difference between the sensed thicknesses (e.g., from the thickness sensor 301) and the predicted thicknesses. In some embodiments, the error may result from disturbances (e.g., inconsistent flow rate of the molten material 121 flowing in the direction 156 in FIG. 2, temperature variations, etc.) or imperfections in the model simulation 505. If the predicted state vector comprising the time delay from 509 (e.g., x_{d}(k−θ)) perfectly matched the measured state vector from 507 (e.g., xₘ(k−θ)), then the delayed state prediction error xₑ(k) may be zero. However, if the predicted state vector comprising the time delay from 509 (e.g., x_{d}(k−θ)) differs from the measured state vector from 507 (e.g., xₘ(k−θ)), then the delayed state prediction error xₑ(k) may be non-zero, and can be filtered by a filter 513 (e.g., to filter out certain frequency ranges). In some embodiments, the filter 513 can generate a filtered delayed state prediction error 521, which may be represented by x_{f} (k). The filtered delayed state prediction error 521 can be added to the delay-free predicated state vector 506 (e.g., x(k)) to produce a corrected state vector 527, which may be represented by x̅(k). The corrected state vector 527 can comprise the feedback which can be received by the delay-free model predictive control 503. The delay-free model predictive control 503 can therefore receive the setpoint 502 and the corrected state vector 527 and adjust the laser apparatus 335 to cause the thickness of the ribbon of glass-forming material 103 to be closer to the setpoint 502.

In some embodiments, the control device 325 of FIG. 4 can comprise the control scheme of FIG. 5, due to the relatively large time delay between the impingement of the laser beam 351, 353, 355, 357, 361, 363, 365, and/or 367 upon the ribbon of glass-forming material 103 and the sensing the thickness of the first ribbon portion 401 following the separation of the first ribbon portion 401 from the second ribbon portion 403. For example, the control scheme of FIG. 5 can comprise the Smith predictor, which incorporates the model simulation 505 to produce the delay-free predicated state vector 506, which may be then subjected to the time delay 509 and compared to the measured state vector 508. In some embodiments, the time delay may be smaller than the time delay of FIG. 4. For example, with reference to FIG. 3, when the thickness sensor 301 is arranged to sense the thickness at locations that are proximate to a location where the laser beam 351, 353, 355, 357, 361, 363, 365, and/or 367 impinges upon the upon the ribbon of glass-forming material 103 (e.g., wherein the thickness sensing and the laser beam impingement both occur prior to separating the first ribbon portion 401), the time delay may be minimal or nearly zero, and the control device 325 may not comprise the Smith predictor, for example, the model simulation 505 that produces the delay-free predicated state vector 506 which may then be subjected to the time delay 509. Rather, in some embodiments, the control device 325 of FIG. 3 may comprise the delay-free model predictive control 503.

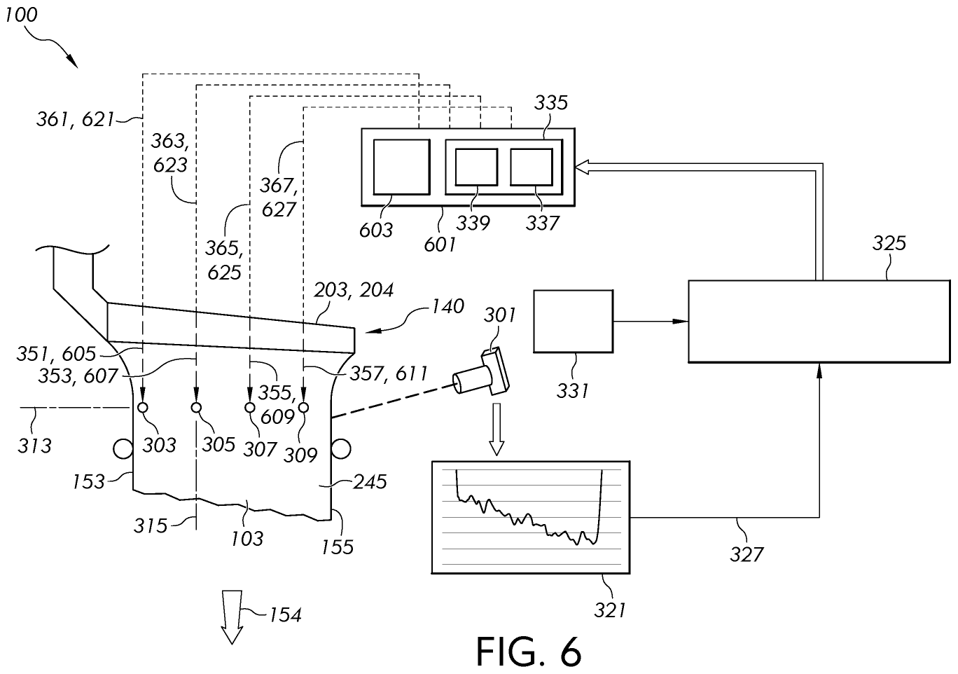

Referring to FIG. 6, in some embodiments, the control device 325 can control one or both of heating the ribbon of glass-forming material 103 (e.g., to decrease a viscosity and reduce a thickness) or cooling the ribbon of glass-forming material 103 (e.g., to increase a viscosity and increase a thickness at a location). For example, in some embodiments, the glass manufacturing apparatus 100 of FIG. 6 can be similar in some respects to the glass manufacturing apparatus 100 of FIG. 3 and/or FIG. 4. For example, the glass manufacturing apparatus 100 of FIG. 6 can comprise the thickness sensor 301 that can measure the thickness of the ribbon of glass-forming material 103 prior to separating the first ribbon portion 401 from the second ribbon portion (e.g., as illustrated in FIG. 4). In some embodiments, the thickness sensor 301 can generate the thickness profile 321 and transmit the thickness profile 321 through the communication line 327 to the control device 325. The control device 325 can receive the target thickness profile 331 and, based on a comparison between the thickness profile 321 and the target thickness profile 331, the control device 325 can transmit instructions to an adjustment apparatus 601.

In some embodiments, the adjustment apparatus 601 can comprise one or more structures for heating and/or cooling the ribbon of glass-forming material 103. For example, in some embodiments, the adjustment apparatus 601 can comprise the laser apparatus 335. The laser apparatus 335 can comprise the laser generator 337 and the beam-directing apparatus 339. In some embodiments, the laser generator 337 can emit a laser beam that can be directed toward one of the locations 303, 305, 307, or 309 of the ribbon of glass-forming material 103, which can decrease the viscosity at the location 303, 305, 307, or 309. In some embodiments, the adjustment apparatus 601 can comprise a cooling apparatus 603. The cooling apparatus 603 can comprise, for example, a cooling tube with one or more openings formed in a wall of the cooling tube. The cooling tube may be hollow and can receive a cooling fluid, for example, air. The cooling fluid can flow through the one or more openings in the wall of the cooling tube and can be directed toward the ribbon of glass-forming material 103. In some embodiments, by directing the cooling fluid toward one of the locations 303, 305, 307, or 309 of the ribbon of glass-forming material 103, the cooling apparatus 603 can increase the viscosity at one of the locations 303, 305, 307, or 309 and increase the thickness.

In some embodiments, methods of manufacturing a glass ribbon can comprise identifying the first location 303 of the plurality of locations in which a first corresponding thickness at the first location 303 exceeds a target thickness. For example, the first corresponding thickness at the first location 303 may be measured by the thickness sensor 301, and the control device 325 can compare the first corresponding thickness to the target thickness from the target thickness profile 331. If the first corresponding thickness exceeds the target thickness, then, in some embodiments, methods can comprise directing the laser beam 351 and/or 361 toward the ribbon of glass-forming material 103 to decrease the viscosity at the first location 303 and attain the target thickness at the first location 303. In some embodiments, directing the laser beam 351 and/or 361 can comprise directing the laser beam 351 and/or 361 toward one or more of the first stream 241 of glass-forming material flowing over the first weir 203, the second stream 243 of glass-forming material flowing over the second weir 204, or the fused ribbon 245. In some embodiments, methods of manufacturing a glass ribbon can comprise identifying the second location 305 of the plurality of locations in which a second corresponding thickness at the second location 305 is less than the target thickness. For example, the second corresponding thickness at the second location 305 may be measured by the thickness sensor 301, and the control device 325 can compare the second corresponding thickness to the target thickness from the target thickness profile 331. If the second corresponding thickness is less than the target thickness, then, in some embodiments, a cooling fluid 605, 607, 609, 611, 621, 623, 625, and/or 627 can be directed toward the ribbon of glass-forming material 103 to increase a viscosity at a particular location and attain a target thickness at that location. The cooling fluid 605, 607, 609, 611, 621, 623, 625, and/or 627 can be direction toward identical locations of the ribbon of glass-forming material 103 as the laser beam 351, 353, 355, 357, 361, 363, 365, and/or 367. For example, in some embodiments, the cooling fluid 605, 607, 609, and/or 611 can be directed toward the fused ribbon 245, though, in some embodiments, the cooling fluid 621, 623, 625, and/or 627 can be directed toward one or both of the first stream 241 of glass-forming material flowing over the first weir 203 or the second stream 243 of glass-forming material flowing over the second weir 204.

In some embodiments, if the second location 305 is identified as comprising a second corresponding thickness that is less than the target thickness, methods of manufacturing a glass ribbon can comprise directing a cooling fluid 607 and/or 623 toward the ribbon of glass-forming material 103 to increase a viscosity at the second location 305 and attain the target thickness at the second location 305. For example, directing the cooling fluid 607 can comprise directing the cooling fluid 607 and/or 623 toward one or more of the first stream 241 of glass-forming material flowing over the first weir 203, the second stream 243 of glass-forming material flowing over the second weir 204, or the fused ribbon 245. For example, the cooling fluid 623 can be directed toward one or more of the first stream 241 of glass-forming material flowing over the first weir 203 or the second stream 243 of glass-forming material flowing over the second weir 204, while the cooling fluid 607 can be directed toward the second location 305 of the fused ribbon 245. In this way, the control device 325 can cause a change in the thickness of the ribbon of glass-forming material 103 based on whether a thickness at a particular location exceeds or is less than a target thickness. For example, when the measured thickness exceeds a target thickness at a particular location, the control device 325 can cause the laser beam 351, 353, 355, 357, 361, 363, 365, and/or 367 to impinge upon the ribbon of glass-forming material 103 and decrease the viscosity, thus decreasing a thickness and attaining the target thickness at that location. When the measured thickness is less than a target thickness at a particular location, the control device 325 can cause the cooling fluid 605, 607, 609, 611, 621, 623, 625, and/or 627 to impinge upon the ribbon of glass-forming material 103 and increase the viscosity, thus increasing a thickness and attaining the target thickness at that location.

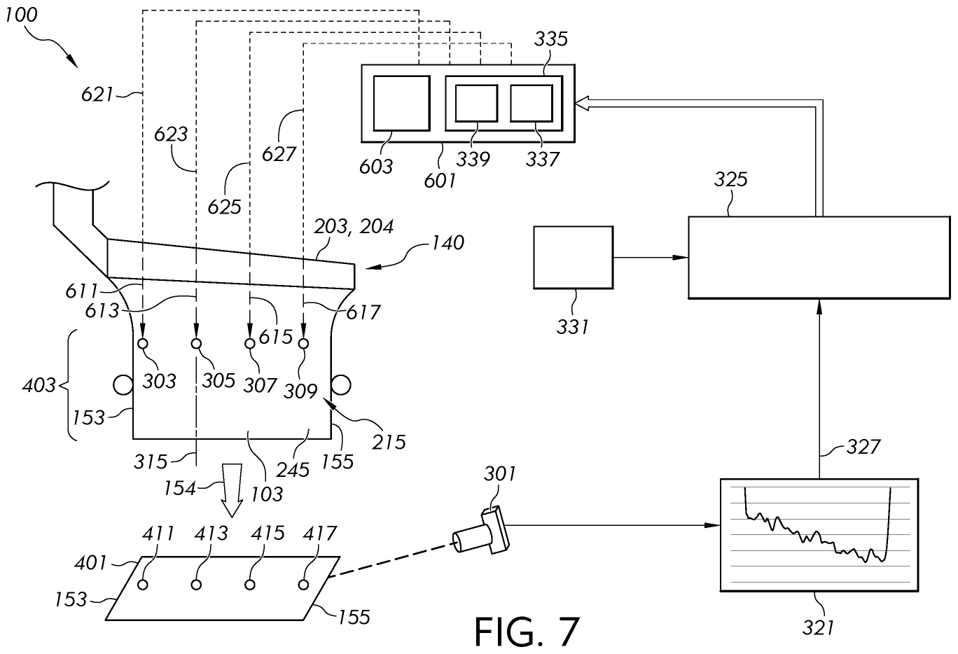

Referring to FIG. 7, in some embodiments, the control device 325 can control one or more of heating the ribbon of glass-forming material 103 (e.g., to decrease a viscosity and reduce a thickness) or cooling the ribbon of glass-forming material 103 (e.g., to increase a viscosity and increase a thickness at a location) based on a sensed thickness of the first ribbon portion 401 that has been separated from the second ribbon portion 403. For example, in some embodiments, the glass manufacturing apparatus 100 of FIG. 7 can be similar in some respects to the glass manufacturing apparatus 100 of FIG. 3, FIG. 4, and FIG. 6. For example, the glass manufacturing apparatus 100 of FIG. 7 can comprise the thickness sensor 301 that can measure the thickness of the first ribbon portion 401 after separating the first ribbon portion 401 from the second ribbon portion 403. In some embodiments, the thickness sensor 301 can generate the thickness profile 321 and transmit the thickness profile 321 through the communication line 327 to the control device 325. The control device 325 can receive the target thickness profile 331 and, based on a comparison between the thickness profile 321 and the target thickness profile 331, the control device 325 can transmit instructions to the adjustment apparatus 601, which can comprise the laser apparatus 335 and the cooling apparatus 603.

In some embodiments, methods of manufacturing a glass ribbon can comprise generating a predicted thickness profile of the ribbon of glass-forming material 103 comprising predicted thicknesses at the plurality of locations 303, 305, 307, and/or 309. For example, in some embodiments, the predicted thickness profile can comprise the model predictive control 503 illustrated in FIG. 5. The model predictive control 503 can predict future behavior of the process, for example, the predicted thickness profile of the ribbon of glass-forming material 103 at the plurality of locations 303, 305, 307, or 309 at certain times into the future. In some embodiments, identifying a first location (e.g., in which a corresponding thickness at the first location exceeds a target thickness) can comprise comparing the predicted thickness profile with the thicknesses sensed at the plurality of locations 411, 413, 415, or 417. For example, with reference to FIG. 5, the comparison 511 can be made between the predicted state vector 510, which may be obtained from the model predictive control 503, and the measured state vector 508, which can comprise the thickness sensed at the plurality of locations 411, 413, 415, or 417 by the thickness sensor 301. Based on the comparison, if a difference exists, then the difference may be represented by the filtered delayed state prediction error 521. In some embodiments, methods of manufacturing a glass ribbon can comprise generating a second thickness profile of the second ribbon portion 403 based on the comparison between the predicted thickness profile and the thickness sensed at the plurality of locations 411, 413, 415, or 417. For example, as illustrated in FIG. 5, the filtered delayed state prediction error 521 can be added to the delay-free predicated state vector 506 to produce the corrected state vector 527. The corrected state vector 527 can be transmitted to the model predictive control 503, whereupon the model predictive control 503 can be updated based on the corrected state vector 527, thus generating a second thickness profile. In some embodiments, the second thickness profile can comprise an updated thickness profile (e.g., after the initial predicted thickness profile), and the control device 325 can deliver control instructions to the adjustment apparatus 601 based on the second thickness profile.

In some embodiments, the control instructions that can be delivered by the control device 325 to the adjustment apparatus 601 can comprise instructions to heat and/or cool the second ribbon portion 403. For example, in some embodiments, methods of manufacturing a glass ribbon can comprise identifying a third location 415 of the plurality of locations 411, 413, 415, or 417 in which a third corresponding thickness at the third location is less than the target thickness. In some embodiments, methods of manufacturing a glass ribbon can comprise directing a cooling fluid, for example, a third cooling fluid 615 and/or 625 toward a fourth location 309 of the second ribbon portion 403 corresponding to the third location 415 of the first ribbon portion 401 to increase a viscosity at the fourth location 309 and attain the target thickness at the fourth location 309.

By sensing a thickness of the ribbon of glass-forming material 103 with the thickness sensor 301, a thickness profile can be generated and transmitted to the control device 325. The control device 325 can compare the sensed thickness profile with a target thickness profile and/or a predicted thickness profile, and cause heating (e.g., via the laser apparatus 335) and/or cooling (e.g., via the cooling apparatus 603) at a location of the ribbon of glass-forming material 103 to adjust the thickness at that location. In some embodiments, for example, as illustrated in FIG. 3 and FIG. 6, the control device 325 can comprise a real-time control of the thickness, due to the close proximity between the location at which the thickness is sensed by the thickness sensor 301, and the location at which the heating and/or cooling of the ribbon of glass-forming material 103 occurs. In addition, or in the alternative, in some embodiments, as illustrated in FIG. 4 and FIG. 7, the control device 325 can account for a time delay caused by the separation of the first ribbon portion 401 prior to the thickness of the first ribbon portion 401 being sensed by the thickness sensor 301. In some embodiments, as illustrated in FIG. 5, the control device 325 can model the impact of the laser apparatus 335 (and/or the cooling apparatus 603) by generating a predicted thickness profile that can predict the thickness response based on a power of the laser apparatus 335 (and/or the cooling apparatus 603), the time delay, the thickness change at a location and surrounding locations based on an input, etc. As such, the control scheme of FIG. 5 can provide for more accurate control of the thickness.

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A method of manufacturing a glass ribbon comprising:
moving a ribbon of glass-forming material along a travel path in a travel direction;
sensing a thickness of the ribbon of glass-forming material at a plurality of locations of the ribbon of glass-forming material;
identifying a location of the plurality of locations in which a corresponding thickness at the location exceeds a target thickness;
correlating a rate of thickness change and a thickness difference between the corresponding thickness and the target thickness to a laser power; and
directing a laser beam at the laser power toward the ribbon of glass-forming material to decrease a viscosity at the location and attain the target thickness at the location.

2. The method of claim 1, wherein the identifying comprises identifying a second location of the plurality of locations in which a second corresponding thickness at the second location is less than the target thickness.

3. The method of claim 2, further comprising directing a cooling fluid toward the ribbon of glass-forming material to increase a viscosity at the second location and attain the target thickness at the second location.

4. The method of claim 1, further comprising:
flowing a first stream of glass-forming material over a first weir of a forming wedge;
flowing a second stream of glass-forming material over a second weir of the forming wedge;
fusing the first stream of glass-forming material and the second stream of glass-forming material to form a fused ribbon.

5. The method of claim 4, wherein the directing the laser beam comprises directing the laser beam toward one or more of the first stream of glass-forming material flowing over the first weir, the second stream of glass-forming material flowing over the second weir, or the fused ribbon.

6. The method of claim 1, wherein the sensing the thickness of the ribbon of glass-forming material occurs at the plurality of locations spaced apart along a first axis substantially perpendicular to the travel direction.

7. The method of claim 1, wherein the sensing the thickness of the ribbon of glass-forming material occurs in a first ribbon portion of the ribbon of glass-forming material after separating the first ribbon portion from a second ribbon portion of the ribbon of glass-forming material.

8. A method of manufacturing a glass ribbon comprising:
moving a ribbon of glass-forming material along a travel path in a travel direction;
sensing a thickness of the ribbon of glass-forming material at a plurality of locations of the ribbon of glass-forming material;
identifying a first location of the plurality of locations in which a first corresponding thickness at the first location exceeds a target thickness and a second location of the plurality of locations in which a second corresponding thickness at the second location is less than the target thickness;
directing a laser beam toward the ribbon of glass-forming material to decrease a viscosity at the first location and attain the target thickness at the first location; and
directing a cooling fluid toward the ribbon of glass-forming material to increase a viscosity at the second location and attain the target thickness at the second location.

9. The method of claim 8, further comprising:
flowing a first stream of glass-forming material over a first weir of a forming wedge;
flowing a second stream of glass-forming material over a second weir of the forming wedge; and
fusing the first stream of glass-forming material and the second stream of glass-forming material to form a fused ribbon.

10. The method of claim 9, wherein the directing the laser beam comprises directing the laser beam toward one or more of the first stream of glass-forming material flowing over the first weir, the second stream of glass-forming material flowing over the second weir, or the fused ribbon.

11. The method of claim 9, wherein the directing the cooling fluid comprises directing the cooling fluid toward one or more of the first stream of glass-forming material flowing over the first weir, the second stream of glass-forming material flowing over the second weir, or the fused ribbon.

12. The method of claim 8, wherein the sensing the thickness of the ribbon of glass-forming material occurs in a first ribbon portion of the ribbon of glass-forming material after separating the first ribbon portion from a second ribbon portion of the ribbon of glass-forming material.

13. The method of claim 12, further comprising:
calculating a time delay between the separating of the first ribbon portion and the sensing of the thickness; and
directing the laser beam and the cooling fluid toward the second ribbon portion based on the time delay.

14. A method of manufacturing a glass ribbon comprising:
moving a ribbon of glass-forming material along a travel path in a travel direction;
separating a first ribbon portion of the ribbon of glass-forming material from a second ribbon portion of the ribbon of glass-forming material;
sensing a thickness at a plurality of locations of the first ribbon portion;
identifying a first location of the plurality of locations in which a corresponding thickness at the first location exceeds a target thickness;
calculating a time delay between the separating of the first ribbon portion and the sensing of the thickness; and
directing a laser beam at a laser power based on the time delay toward a second location of the second ribbon portion corresponding to the first location of the first ribbon portion to decrease a viscosity at the second location and attain the target thickness at the second location.

15. The method of claim 14, further comprising generating a predicted thickness profile of the ribbon of glass-forming material comprising predicted thicknesses at the plurality of locations.

16. The method of claim 15, wherein the identifying the first location comprises comparing the predicted thickness profile with the thicknesses sensed at the plurality of locations.

17. The method of claim 16, further comprising generating a second thickness profile of the second ribbon portion based on the comparison between the predicted thickness profile and the thicknesses sensed at the plurality of locations.

18. The method of claim 14, further comprising identifying a third location of the plurality of locations in which a third corresponding thickness at the third location is less than the target thickness.

19. The method of claim 18, further comprising directing a cooling fluid toward a fourth location of the second ribbon portion corresponding to the third location of the first ribbon portion to increase a viscosity at the fourth location and attain the target thickness at the fourth location.

20. A method of manufacturing a glass ribbon comprising:
moving a ribbon of glass-forming material along a travel path in a travel direction;
sensing a thickness of the ribbon of glass-forming material at a plurality of locations of the ribbon of glass-forming material;
identifying one or more of:
a location of the plurality of locations in which a corresponding thickness at the location exceeds a target thickness; or
a second location of the plurality of locations in which a second corresponding thickness at the second location is less than the target thickness;
correlating a rate of thickness change and a thickness difference between the corresponding thickness and the target thickness to a laser power when the corresponding thickness at the location exceeds the target thickness; and
directing one or more of:
a laser beam at the laser power toward the ribbon of glass-forming material to decrease a viscosity at the location and attain the target thickness at the location; or
a cooling fluid toward the ribbon of glass-forming material to increase a viscosity at the second location and attain the target thickness at the second location.
